(19) United States
(12) Patent Application Publication
(10) Pub. No.: US 2009/0217536 A1
(43) Pub. Date: Sep. 3, 2009

(54) HAND TOOL WITH INTERCHANGEABLE TOOL ELEMENTS

(76) Inventor: Simon MEDHURST, Burlington (CA)

Correspondence Address: Hofbauer Professional Corporation, Suite 3-166, 3350 Fairview Street, Burlington, ON, L7N 3L5, CA

(21) Appl. No.: 12/391,557

(22) Filed: Feb. 24, 2009

Related U.S. Application Data
(60) Provisional application No. 61/032,925, filed on Feb. 29, 2008.

(51) Int. Cl. B26B 5/00

(52) U.S. Cl. 30/337

(57) ABSTRACT

A hand held cutting tool is provided for use with at plurality of different tool elements each having a two-sided shank portion of distinct longitudinal profile. The hand held cutting tool is described as comprising: (a) a barrel portion defining an equal plurality of longitudinally extending channels therewithin, with each said channel having a complimentary outline shape and otherwise dimensioned to receive one of said shank portions therewithin in close fitting relation, with a first side of said shank portion positioned adjacent the base of said channel; (b) one or more housing means mounted on the barrel portion for selectively contacting said shank portion remote from said first side to retain the respective tool element in mated held-fast relation within each said channel; and, (c) a handle portion attached to said barrel portion.

### FIELD OF THE INVENTION

This invention relates generally to the field of hand tools, and more particularly to those having interchangeable tool elements, such as a knife blade or the like.

### BACKGROUND OF THE INVENTION

The field of hand held tools is one in which various previously known types of hand tools may have had interchangeable tool elements. For example, screw driver handles are known that have interchangeable screw driver bits for accommodating screw heads having different drive patterns. Also, utility knife handles are known that have interchangeable cutting blades. The vast majority of such utility knife handles provide for the use of a single type of cutting blade, typically being the standard quadrilateral-shaped utility blades having upper and lower parallel edges, the lower of which is typically sharpened and of generally longer length than the upper edge, with the upper edge typically being unsharpened and having one or more notches designed to index with a holding means mounted in the body of the utility knife. The other two opposed edges are also typically unsharpened, and are generally shorter and angled congruently, but in opposite directions from one another, to provide for a reversible blade having two points. A prior art utility knife blade of this general type is shown at reference numeral 21 in attached FIG. 1a.

Most utility knives provide for replacement of a blade when it becomes dull or broken, and some even provide for interchangeability of the standard utility knife blades 21 with blades having different profiles. For example a standard utility knife blade 21 may be replaced with a hooked blade (not shown) for cutting linoleum or the like.

Typically, however, the length and style of blades that can be interchanged with the handles of known utility knives are somewhat limited, with all being of the same general thickness, length and shank profile, as such, the shank portion must be accepted by, and held fast within, the blade holding means associated with the handle of the knife. In other words, the means for releasably holding the knife blade by its shank portion is typically static in the prior art, in the sense that such means is only capable of accommodating one particular profile and thickness of blade shank. Similarly, known screw driver handles accommodating interchangeable tool elements (in the form of screw driver bits) will (in the absence of having an adjustable chuck mechanism), only accept screw driver bits of a shank with a single cross-sectional profile. This is particularly limiting when one considers that limiting the length and/or thickness of the shank portion of a tool element will also place significant limitations on the overall length and size of the tool element that can be successfully anchored and supported thereby. Thus, prior art hand tools for use with interchangeable tool elements typically have relatively small handles for small length tool elements, and relatively larger handles for longer length tool elements.

Another manner of providing different tool elements in association with a single hand tool takes the form of the well-known Swiss Army Knife™, available from, for example, Wenger S. A., of Delemont, Switzerland, which may have eight or more tool elements associated with a single knife handle. These tool elements may take many forms in addition to screw driver bits, sawing blades or cutting blades, including, for example and without limitation, corkscrews, can openers, scissors, magnifying glasses, cutlery items namely, forks, spoons, knives and the like, and the term “tool element” is used herein to have an equally broad scope of coverage. Nonetheless, the Swiss Army Knife™ solution for providing different tool elements in association with a single hand tool is different from that of the present invention, as the Swiss Army Knife™ uses a separate mounting means for attachment of each respective tool element to the body of the knife handle, which means that such tool elements are not truly “interchangeable” within the meaning of this word as used herein.

### SUMMARY OF THE INVENTION

In accordance with the present invention there is disclosed a hand held cutting tool which comprises and/or is for use with one of the following parts: a barrel portion having a plurality of longitudinally extending channels therewithin; at least two interchangeable tool elements each having different longitudinal cross-sectional shank profiles; and a handle portion.

According to one aspect of the invention, the internal chamber may preferably, but need not necessarily, be adapted to accommodate therein at least two interchangeable tool elements with each having different longitudinal cross-sectional shank profiles.

According to another aspect of the invention, the barrel portion may preferably, but need not necessarily, comprise a dividing member with recessed receiving portions formed therein that may preferably, but need not necessarily, correspond substantially with the cross-sectional shank profile of one of the two tool elements.

According to another aspect of the invention, a shank portion of a first one of the tool elements may preferably, but need not necessarily, be operable to mate with the recessed receiving portion of a first side of the dividing member and a shank portion of a second one of said tool elements may preferably, but need not necessarily, be operable to mate with the recessed receiving portion of a second side of the dividing member.

According to still another aspect of the invention, the barrel portion may preferably, but need not necessarily, comprise a dividing member with substantially flat non-recessed surfaces and at least two recessed receiving members in contacting relation with opposite sides of the dividing member, the recessed receiving members each having a recessed receiving portion formed therein that corresponds substantially with the cross sectional shank profile of one of the two tool elements.

According to yet another aspect of the invention, a shank portion of a first one of the tool elements, may preferably but need not necessarily, be operable to mate with the recessed receiving portion of a first one of the recessed receiving members and a shank portion of a second one of the tool elements, may preferably but need not necessarily, be operable to mate with the recessed receiving portion of a second one of the recessed receiving members.

According to still yet another aspect of the invention, the barrel portion of the cutting tool may preferably, but need not necessarily further comprise one or more securing/guard plates overlying the shank portion of a selected one of the tool elements, and pivotally mounted on the barrel portion, the securing plates may preferably, but need not necessarily be adapted to retain each of said tool elements within the barrel portion of the hand tool.

According to a further aspect of the invention the barrel portion, may preferably but need not necessarily, further comprise a locking member pivotally mounted on an upper surface of the barrel portion and movable from an open unlocked position substantially transverse to the upper surface of the barrel portion to a closed locked position substantially parallel to the upper surface of the barrel position such that, in the closed locked position, the locking member overlies the upper surface of the barrel portion and an upper edge of one or more of the securing plates when the one or more securing plates overlay the shank portion of at least one of the tool elements.

According to a yet further aspect of the invention, the handle and barrel portion of the hand tool, may preferably but need not necessarily, be pivotally attached to each other by means of a first pivot and may preferably be pivotable thereabout.

### BRIEF DESCRIPTION OF THE DRAWINGS

The novel features which are believed to be characteristic of the hand held cutting tool according to the present invention, as to its structure, organization, use and method of operation, together with further objectives and advantages thereof, will be better understood from the following drawings in which various embodiments of the invention will now be illustrated by way of example. It is expressly understood, however, that the drawings are for the purpose of illustration and description only, and are not intended as a definition of the limits of the invention. In the accompanying drawings:

FIG. 1a is a side elevational view of a hand tool according to a first embodiment of the present invention with one cutting element inserted therein and with one cutting element removed therefrom;

FIG. 1b is a side elevational view of the hand tool opposite to the side view shown in FIG. 1a, on a reduced scale;

FIG. 1c is an front perspective view of the hand tool shown in FIG. 1a;

FIG. 2 is an exploded side perspective view of the hand tool of FIG. 1a, shown in a first partially disassembled configuration;

FIG. 2a is a partially exploded front perspective view of the hand tool shown in FIG. 2;

FIG. 2b is an enlarged side elevational view of the encircled area A of FIG. 2a;

FIG. 3 is a further exploded front perspective view of the hand tool of FIG. 2a;

FIG. 3a is a front elevational view of the hand tool shown in FIG. 3;

FIG. 3b is a front perspective view similar to FIG. 3a, with a first cutting tool shown removed therefrom;

FIG. 3c is a side perspective view similar to FIG. 3b, shown with a second cutting tool inserted therein;

FIG. 4a is a further exploded side perspective view of the hand tool of FIG. 3c;

FIG. 4b is an front perspective view of the hand tool shown in FIG. 4a;

FIG. 5a is a further exploded front perspective view of the hand tool of FIG. 4a, shown with the second cutting tool removed therefrom;

FIG. 5b is a further exploded front perspective view of the hand tool of FIG. 5a;

FIG. 5c is a fully exploded front perspective view of the hand tool of FIG. 5b;

FIG. 6 is an exploded side perspective view of the hand tool of FIG. 5c, from the opposite side to the side shown in FIG. 5c;

FIG. 7a is a side elevational view of a second hand tool according to another embodiment of the present invention, with the handle portion removed and with two different cutting elements simultaneously inserted therein;

FIG. 7b is a side elevational view of the hand tool of FIG. 7a, from a side opposite to the side shown in FIG. 7a;

FIG. 7c is an front perspective view of the embodiment shown in FIG. 7a;

FIG. 8 is a partially exploded side perspective view of the hand tool of FIG. 7a, shown in a first partially disassembled configuration;

FIG. 9a is a front elevational view of the hand tool shown in FIG. 8, with the cutting element also removed;

FIG. 9b is a further exploded side perspective view of the hand tool of FIG. 9a, shown in a second partially disassembled configuration;

FIG. 10 is a side perspective view of the hand tool of FIG. 9b, from a side opposite to the side shown in FIG. 9b;

FIG. 10a is a further exploded side perspective view of the hand tool of FIG. 10, shown in a third partially disassembled configuration;

FIG. 11 is a top plan view of the hand tool shown in FIG. 10a;

FIG. 12 is an exploded side elevational view of the hand tool shown in FIG. 10a;

FIG. 13 is a further exploded side elevational view of the hand tool of FIG. 12, shown in a completely disassembled configuration, with a second cutting element shown removed therefrom;

FIG. 13a is a side elevational view, on an enlarged scale, of the barrel portion and of a shank portion of the second cutting element shown in FIG. 13;

FIG. 14 is an exploded rear elevational view of the hand tool shown in FIG. 11;

FIG. 15 is front perspective view of yet another embodiment of a hand tool according to the present invention;

FIG. 16 is an exploded right side perspective view of the hand tool of FIG. 15, shown in a partially disassembled configuration;

FIG. 17 is an exploded left side elevational view of the hand tool of FIG. 16, shown in a completely disassembled configuration;

FIG. 17a is an enlarged left side elevational view of the shank portion of the second cutting element and its corresponding recessed receiving portion of the hand tool shown in FIG. 17; and,

FIG. 18 is an exploded top plan view of the hand tool shown in FIG. 17.

### DETAILED DESCRIPTION OF THE PREFERRED EMBODIMENTS

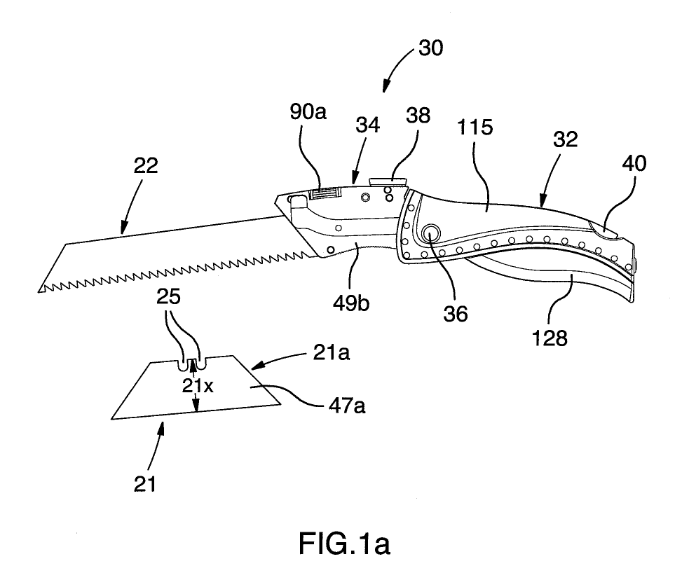

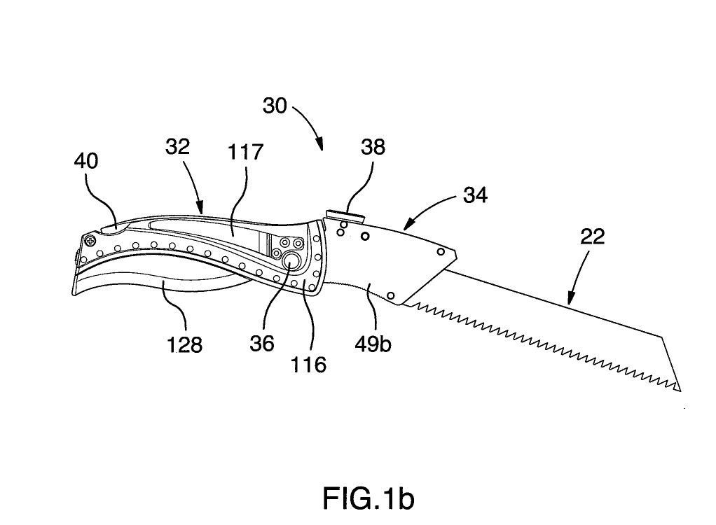

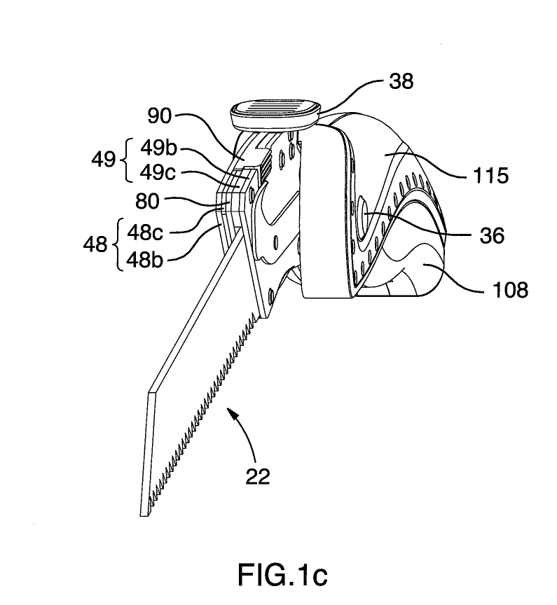

Referring now to FIGS. 1 to 6 of the drawings, there is shown a hand tool in the form of a knife 30 having a pistol grip handle portion 32 and a barrel portion 34. As best seen in FIGS. 1a and 1b, the pistol grip handle portion 32 is mounted to the barrel portion 34 by means of a first pivot 36, and is selectively rotatable thereabout between an inline position having its longitudinal axis substantially aligned with that of the barrel portion 34 (as shown in FIG. 1a) and an angled position having its longitudinal axis substantially transverse to that of the barrel portion 34 (which latter position is not shown in the Figures).

In one embodiment, the handle portion 32 and barrel portion 34 may be formed from a resilient material, preferably a synthetic plastic material and/or a substantially rigid material, preferably a metal material.

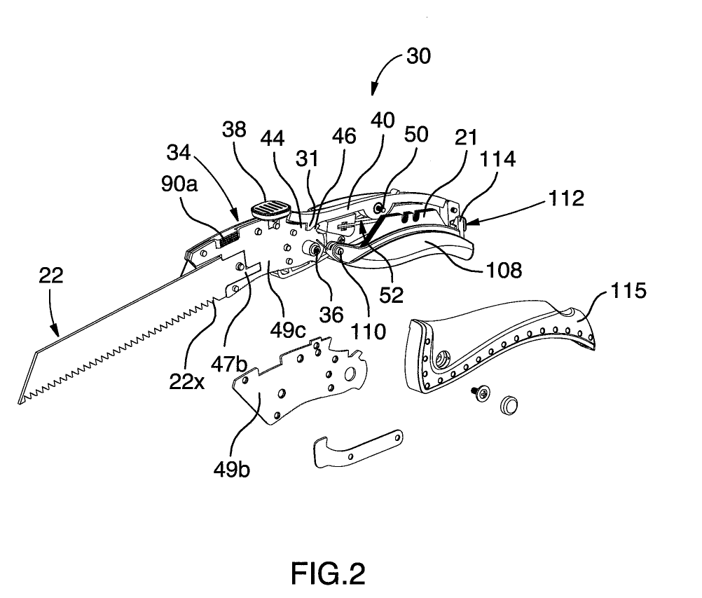

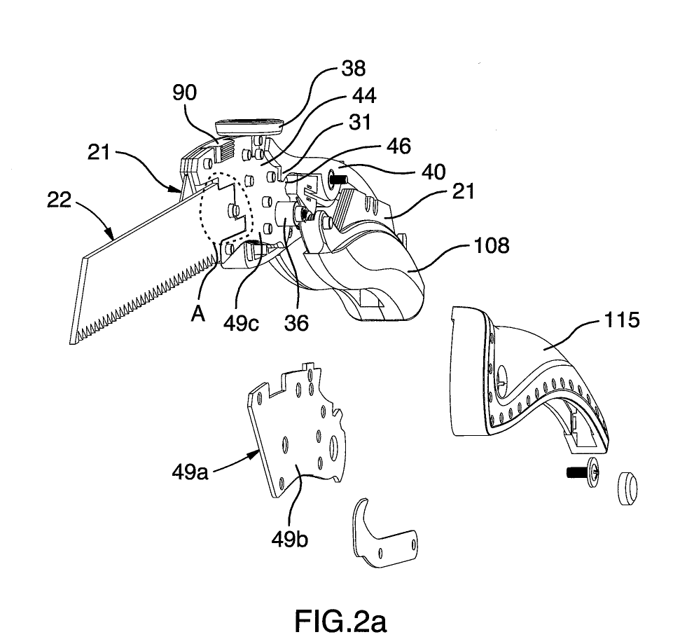

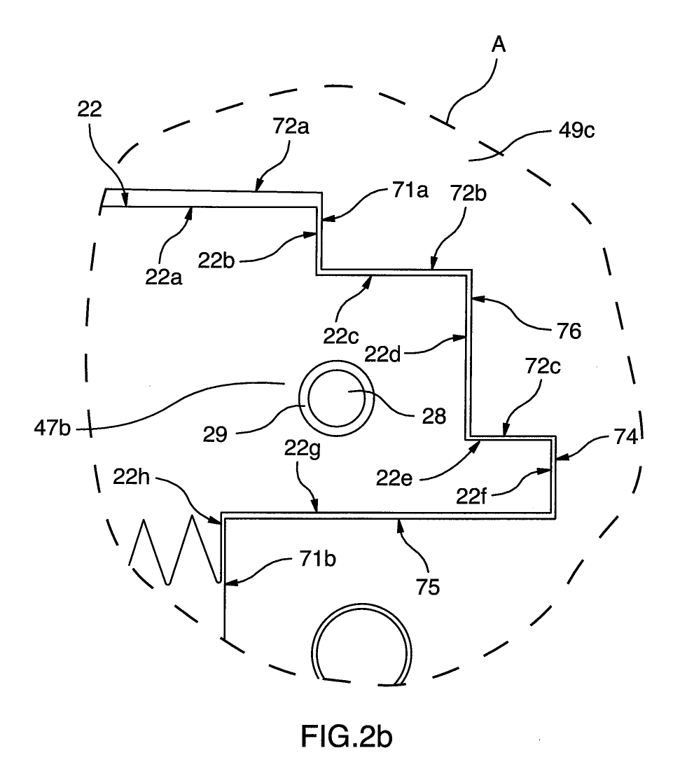

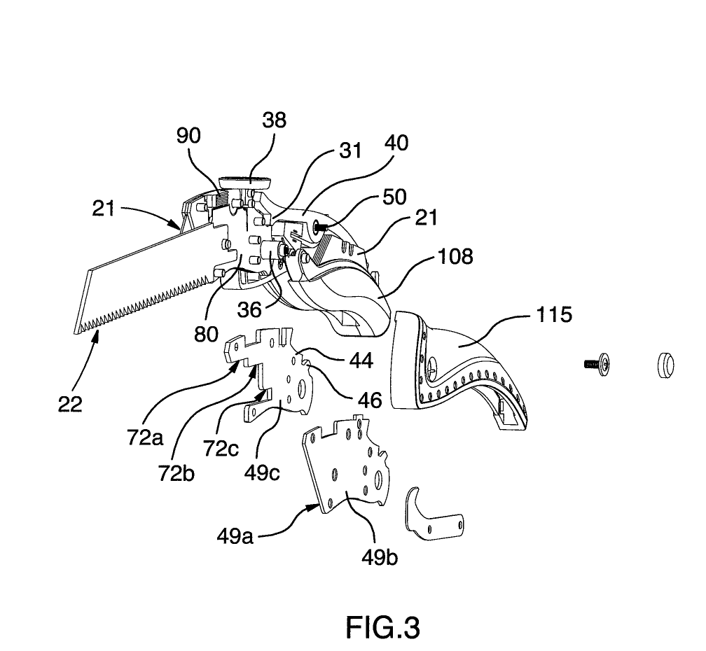

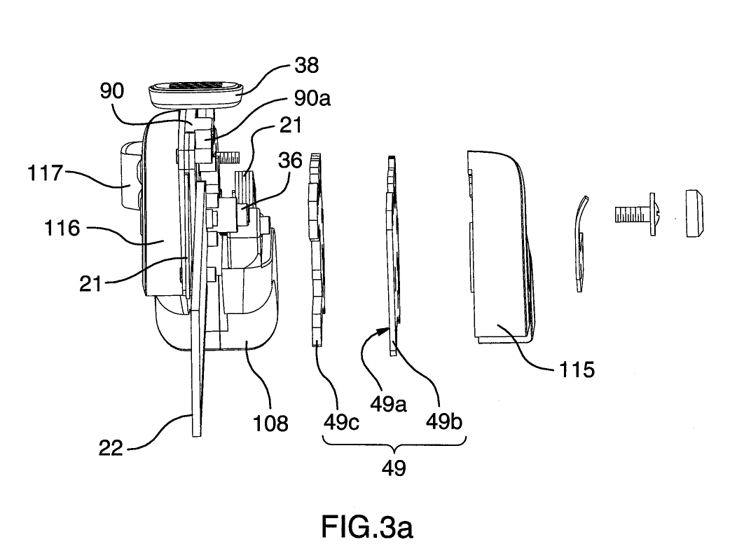

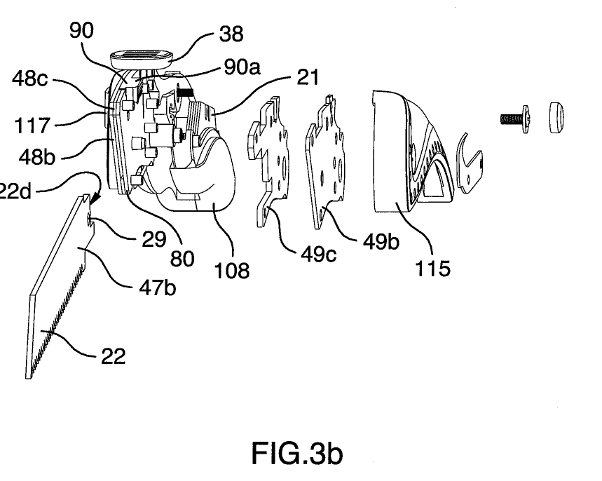

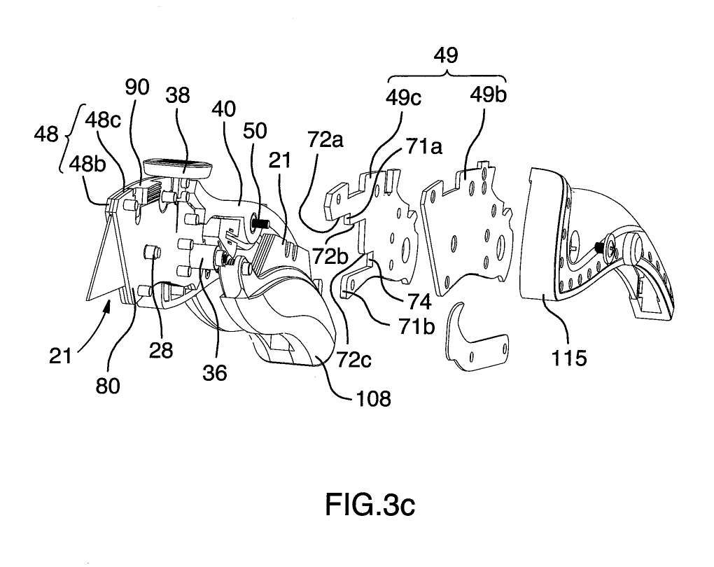

As best seen in FIGS. 2, 2a and 3, the pistol grip handle portion 32 is selectively locked against rotation about first pivot 36 in a selected one of its two described positions by respective locking engagement of pawl tooth 31 positioned adjacent a first end of pawl lever 40 with first 44 and second 46 turkey spurs positioned on the posterior end of the recessed receiving portion 49c. The pawl lever 40 is itself pivotally mounted for rotation about a second pivot 50, with a torsion spring 52 (as best seen in FIG. 2) biasing the pawl lever 40 into said locking engagement. A storage compartment 108 for storing extra utility blades 21 within the body of the knife 30 is optionally mounted on the barrel portion 34 in swing down relation about pivot pin 110. A locking means 114 for this compartment 108 is also optionally provided, which locking means 114 is activated by a push-button mechanism 112 located on the rear end of the pistol grip handle portion 32. Contoured side panels 115 and 116 are provided for mounting on opposite sides of the pistol grip handle portion 32 for aesthetic reasons and to fill out same for the comfort of users. The side panels 115, 116 may be rubberized or otherwise cushioned. A belt clip 117 of resilient metal or plastic material is also optionally mounted on one side of the barrel portion 34. These features are not essential to the invention, but are ancillary arrangements.

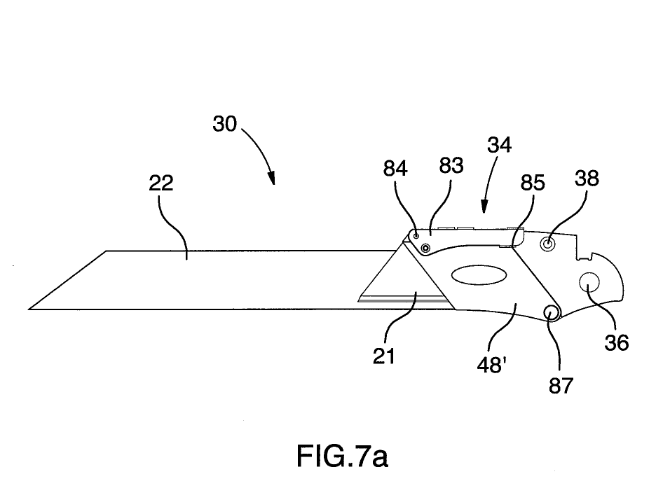

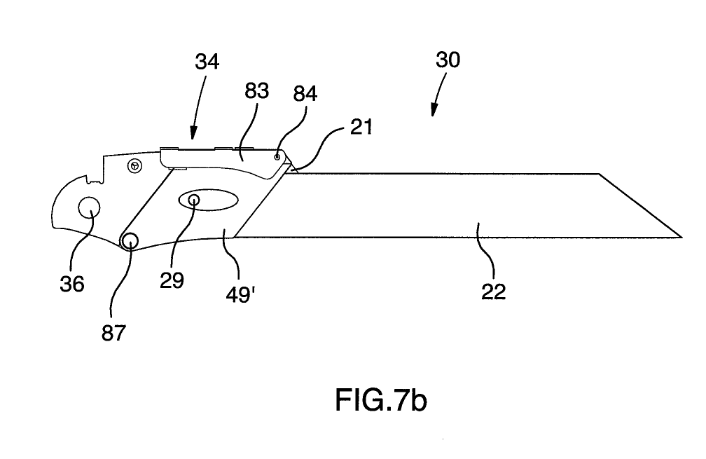

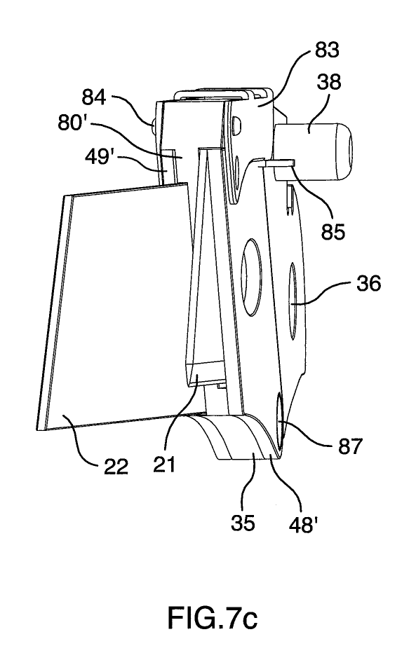

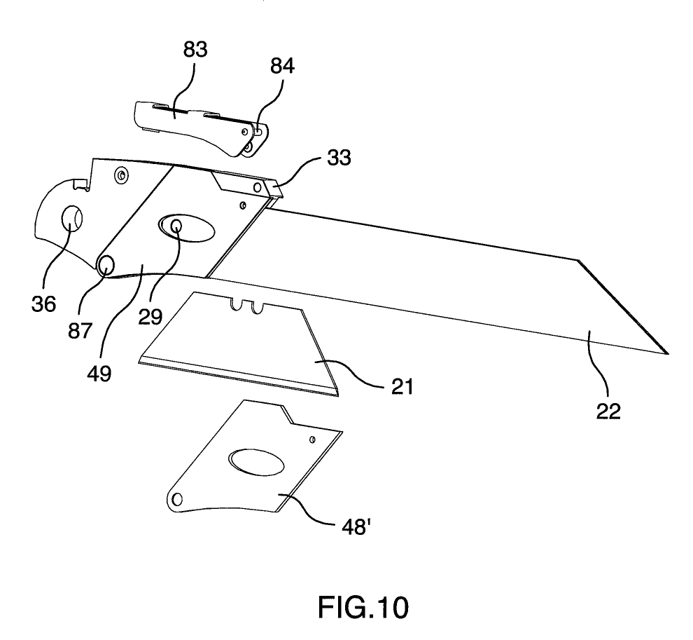

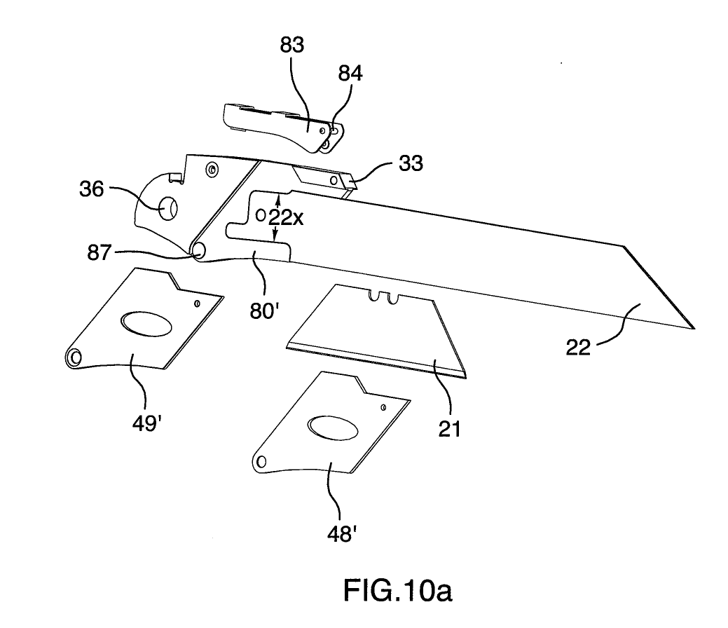

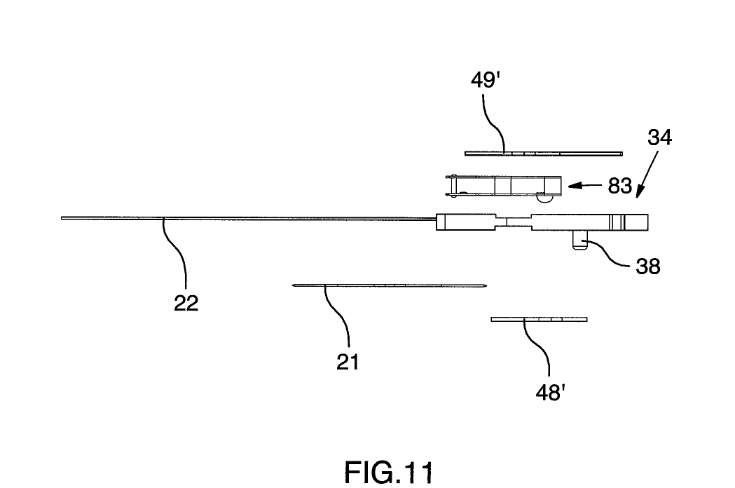

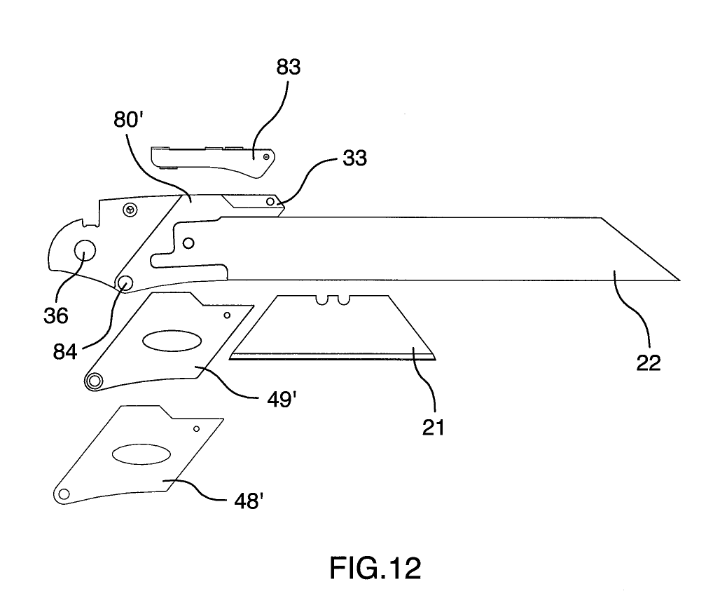

The embodiments of the invention depicted in FIGS. 7a to 18 are shown for simplicity of illustration with the handle portion 32 removed. However, it is to be understood that an analogous handle portion 32 to that described in the foregoing paragraphs is also operable with the barrel portion 34 shown in FIGS. 7a to 18.

As best seen in FIG. 3a, the barrel portion 34 is formed so as to accommodate therein different tool elements, such as, for example, the utility knife blade 21 and a wallboard saw blade 22, each having shank portions, 47a (as best seen in FIG. 1a) and 47b (as best seen in FIG. 2), of different lengths, heights and thicknesses along their respective shank lengths. More particularly, the shank portions 47a, 47b of the different tool elements each have distinct longitudinal profiles, meaning that each shank portion 47a, 47b has a distinct shape when viewed along the length of their longitudinal axis (i.e. a line parallel to the blade surface running lengthwise from the front of the blade to the shank portions thereof).

In one embodiment, as seen in FIG. 1a and as previously discussed, blade 21 is a conventional utility blade, which has a shank height 21x. In contrast, blade 22 is a much longer wallboard saw blade, having a shank height 22x, as best seen in seen in FIG. 2. Shank height 21x is greater than shank height 22x.

In another embodiment, although not shown in the accompanying drawings, the wallboard blade 22 may have a plurality of rearwardly positioned indexing notches (not shown) defined by its top edge so as to provide greater resistance to rotational moments generated during use. In such an alternate configuration, it may be appreciated that the length of the shank (not shown) of wallboard saw blade 22 may be greater than the length of the shank of utility blade 21, as measured rearwardly (i.e. toward the rear of the cutting tool 30) from the congruent and congruently spaced indexing notches 25,25 (shown in FIG. 1a for utility blade 21 and not shown for the saw blade 22) defined by the top edges of each blade 21,22.

As may be best appreciated from FIG. 3a, the thickness of the wallboard saw blade 22 may preferably be markedly greater than that of the utility blade 21.

The features of the barrel portion 34 that facilitate the interchangeability of blades having different lengths, heights and/or thicknesses will now be described in greater detail to illustrate the underlying principles of the present invention.

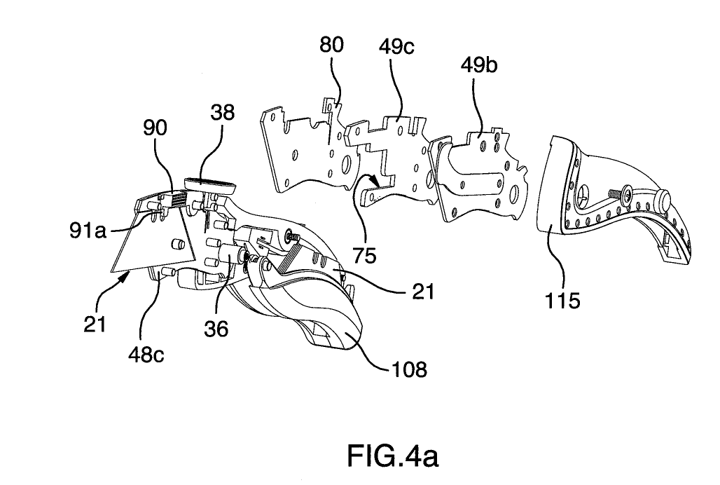

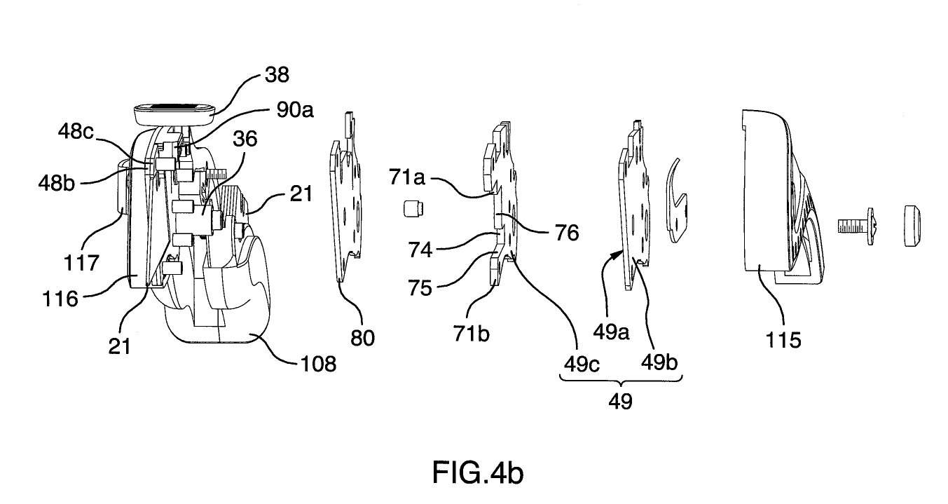

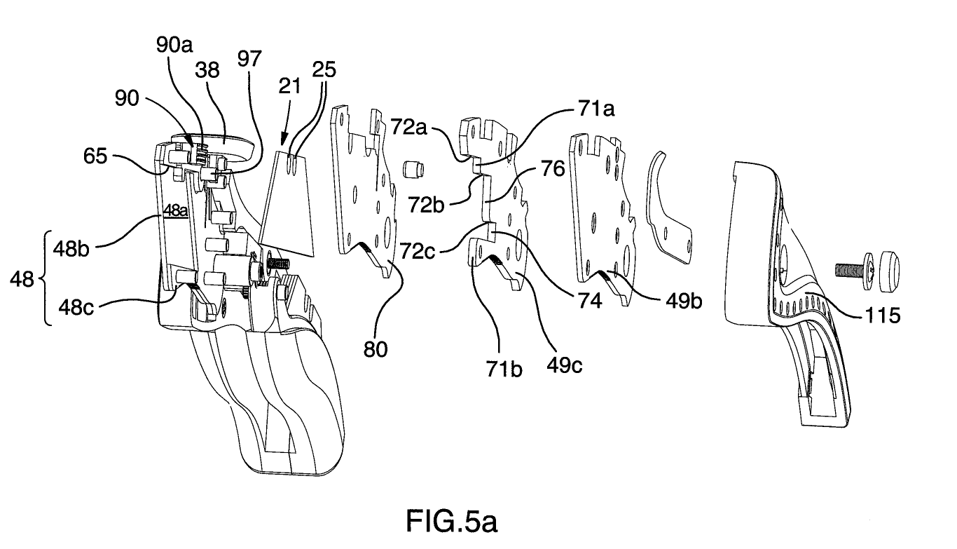

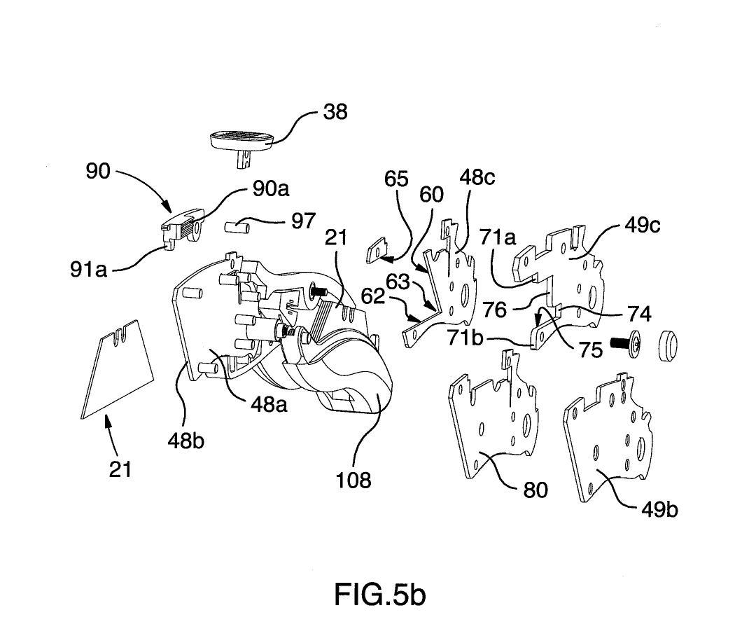

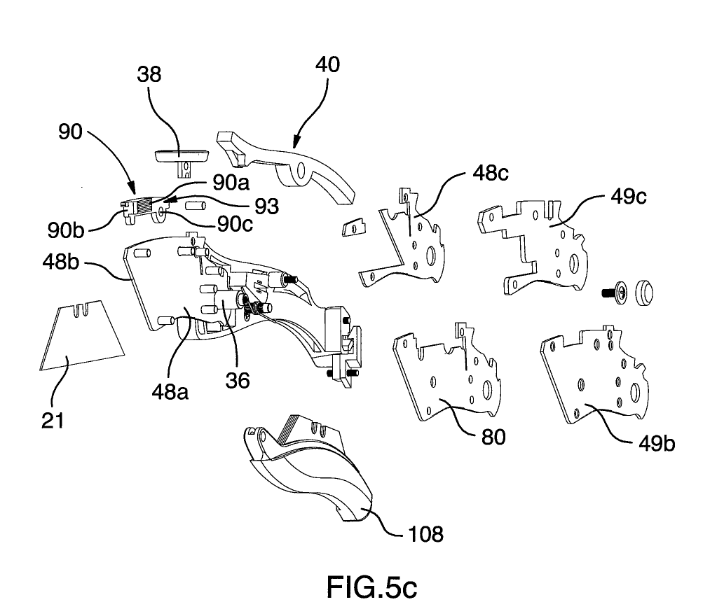

In one embodiment according to the present invention, as best seen in FIGS. 1a to 6, the barrel portion 34 comprises two opposed housing segments, being the first barrel housing segment 48 (as best seen in FIG. 5a) and a second barrel housing segment 49 (as best seen in FIG. 4b). The two housing segments 48 and 49 are not mirror images of one another, but have different recessed profiles formed on their respective inner surfaces 48a (as best seen in FIGS. 5a and 5b) and 49a (as best seen in FIGS. 2a and 3a), and mate with dividing member 80 (as best seen in FIG. 3b), which is situated along a medial plane of the barrel portion 34, to form at least two internal chambers, each having respectively different cross-sectional heights and thickness along the length of their longitudinal axis, with the differences therein accommodating corresponding differences in the cross-sectional height and thickness of the shank portion of an associated blade adapted to be positioned by longitudinally rearward sliding movement into a respective one of said chambers.

As best seen in FIGS. 1c, 3c, 4a, 4b, 5a and 5b, the first barrel housing segment 48, may comprise a barrel housing portion 48b and a recessed receiving portion 48c in contacting relation with each other. The barrel housing portion 48b forms part of the exterior surface of the first barrel housing segment 48, whereas the recessed receiving portion 48c is operable to receive therein a selected one of utility blade 21 or wall board saw blade 22. As best seen in FIGS. 4a and 5a, the recessed receiving portion 48c contains a profile that corresponds substantially with the longitudinal profile of utility blade 21, such that a lateral shank face of the shank portion 47a of the utility blade 21 is received within or mates with the recessed receiving portion 48c.

Likewise, and as also shown in FIGS. 1c, 2, 2a, 3, 3a and 3b, the second barrel housing segment 49, may comprise a barrel housing portion 49b and a recessed receiving portion 49c in contacting relation with each other. The barrel housing portion 49b forms part of the exterior surface of the second barrel housing segment 49, whereas the recessed receiving portion 49c is operable to receive therein a selected one of utility blade 21 or wall board saw blade 22. As best seen in FIGS. 2 and 2a, the recessed receiving portion 49c contains a profile that corresponds substantially with the longitudinal profile of wall board saw blade 22, such that a lateral shank face of the shank portion 47b of the wallboard saw blade 22 is received within or mates with the recessed receiving portion 49c.

It is to be appreciated that the receiving portions 48c, 49c may be fastened to respective inner surfaces 48a (as best seen in FIG. 5c) and 49a (as best seen in FIG. 3a) of the barrel housing portions 48b, 49b via conventional fasteners (e.g. screws, rivets, etc.), not shown.

As best seen in FIGS. 1c, 3b, 3c, 4a, 4b and 5a, the barrel portion 34 may also be provided with a dividing member 80 for contacting relation with the respective other lateral shank faces of the blades 21, 22. The dividing member may provide further assistance in retaining the respective other shank faces in mated held fast relation within the respective recessed receiving portions 48c, 49c. As best seen in FIGS. 4a, 4b, and 5a, the dividing member 80 may preferably be interposed between the recessed receiving portions 48c, 49c. In one embodiment shown in FIGS. 1a to 6, the dividing member 80 may preferably be a plate having flat non-recessed surfaces on opposite sides thereof with a selected one of said flat non-recessed surfaces in contact with the other lateral shank faces of each of blades 21 and 22.

To further assist in retaining the blades 21, 22 in the barrel portion 34, the hand tool 30 may be provided with a blade locking assembly comprised of a rocker member 90 operable to selectively engage at least one shank portion 47a, 47b against unintentional sliding removal of the blade 21, 22.

In some embodiments, rocker member 90 (as best seen in FIG. 5a) is removably insertable into a selected one of the internal chambers to selectively engage a selected one of shank portions 47a, 47b and retain same against unintentional sliding removal of a selected blade 21, 22 from the respective one of said internal chambers.

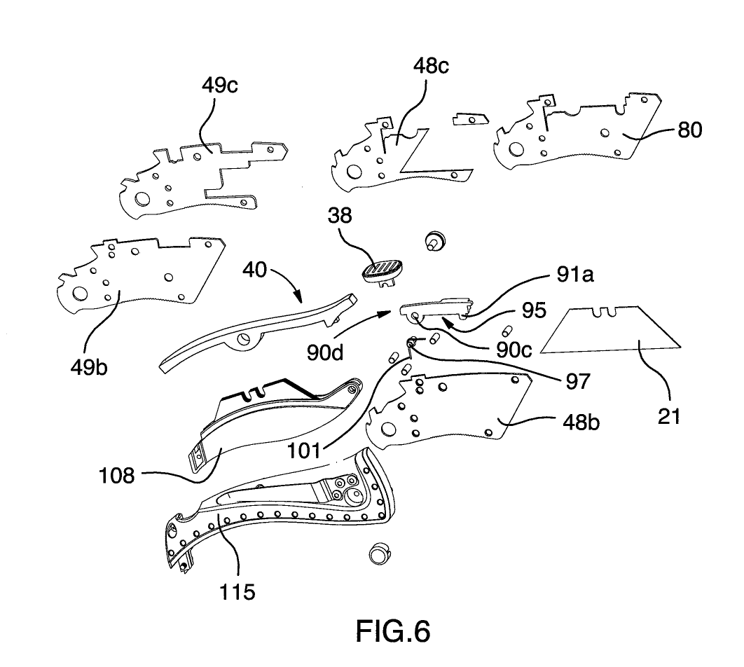

The rocker member 90, (as best seen in FIG. 5c) has a thumb-engagement portion 90a positioned on its side surface 93 adjacent a first longitudinal end 90b, and a mounting bearing 90c positioned adjacent a second opposite second longitudinal end 90d (as best seen in FIG. 6). At least one tooth 91a (as best seen in FIG. 5b), may be longitudinally spaced along the bottom surface 95 (as best seen in FIG. 6) of the rocker member 90. The rocker member 90 is mounted for rotation about its bearing surface 90c by means of a pivot stub 97 (as best seen in FIG. 5a) between a raised unlocked configuration (not shown) and a lowered, locked configuration (which configuration is illustrated in all assembly figures), and in which locked configuration engages with the shank of a selected blade 21, 22 to hold same fast within its respective internal chamber against unintentional forward sliding movement of the blade out of said respective internal chamber.

The rocker member 90 (as best seen in FIG. 5b) is biased to the locked position shown in the drawings by means of a coil spring 101 (as best seen in FIG. 6) mounted about pivot stub 97. The rocker member 90 is moved between its locking and unlocking configuration, respectively, upon urging by a user engaging thumb engagement portion 90a mounted on side surface 93 of rocker member 90 and rotating same upwards.

More particularly, and as best seen in FIGS. 4a and 4b when the conventional utility knife blade 21 is fully inserted in a rearward sliding motion into its respective chamber, and the rocker member 90 is thereafter pivoted to its locked configuration, tooth 91a engages one of the respective indexing notches 25, 25. Lower shoulder 63 (as best seen in FIG. 5b) formed on an internal face of the recessed receiving portion 48c of the first barrel housing segment 48 acts as a stop means to limit rearward sliding movement of the blade 21 within its respective internal chamber.

In this fully inserted configuration, upward movement of the utility blade 21 is limited by engagement of the upper edge of the blade 21 with upper surface 65 (as best seen in FIGS. 5a and 5b) formed on the internal face of the recessed receiving portion 48c of the first barrel housing segment 48. In this fully inserted configuration, downward movement of the utility blade 21 is limited by engagement of the lower sharpened edge of the blade 21 with lower straight edge 62 (as best seen in FIG. 5b) formed on the internal face of the recessed receiving portion 48c of the first barrel housing segment 48. Side-to-side movement of the utility blade 21 is limited by engagement of one side face of the blade 21 with the internal surface 48a (as best seen in FIG. 5b) of the first barrel housing portion 48b, and by engagement of the opposite other side face of the blade 21 with the dividing member 80. In this manner, the utility blade 21 is secured as against unintended movement during use of the knife 30, within the respective chamber in which it is mounted.

Similarly, although not shown in the appended drawings the wall board saw blade 22 may also be provided with a plurality of indexing notches 25, 25. In this embodiment, when the wallboard blade 22 is fully inserted in a rearward sliding motion into its respective internal chamber, and the rocker member 90 is thereafter pivoted to its locked configuration, tooth 91a engages one of the respective indexing notches 25, 25 (not shown) of blade 22 to securely hold the blade 22 in its respective chamber against forward sliding movement of the blade 22.

Additionally, and as best seen in FIG. 2b, the medial 22d and rear 22f trailing edges of the saw blade 22 shank portion 47b respectively engage with congruently shaped medial 76 and rear 74 shoulder surfaces, formed on the internal face of the recessed receiving portion 49c of the second barrel housing segment 49 to act as stop means limiting rearward sliding movement of the blade 22 within its respective internal chamber. Similarly, an upper shoulder surface 71a and a lower shoulder surface 71b both of which are also formed on the internal face of the recessed receiving portion 49c of the second barrel housing segment 49 and are each respectively engageable with the upper 22b and lower 22h trailing edges of the blade body portion (which shoulder surfaces 71a and 71b mark the transition between the blade body portion and the shank portion 47b) to limit rearward sliding movement of the blade 22 within its respective internal chamber.

As also best seen in FIG. 2b, in this fully inserted configuration, upward movement of the wallboard saw blade 22 is limited by engagement of the first upper straight edge 22a, the second upper straight edge 22c and the medial straight edge 22e of the shank portion 47b of the blade 22 with upper straight shoulder surfaces 72a, 72b and medial straight shoulder surface 72c, respectively, formed on the internal face of the recessed portion 49c of the first barrel housing segment 49. Referring to FIG. 2b, downward movement of the saw blade 22 is limited by engagement of the lower straight edge 22g of the shank portion 47b of the blade 22 with lower straight shoulder surface 75 formed on the internal face of the recessed portion 49c of the first barrel housing segment 49. Side-to-side movement of the wallboard saw blade 22 is limited by engagement of one side face of the blade 22 with the internal face 49a of the second barrel segment 49, and by engagement of the opposite other side face of the blade 22 with dividing member 80. Accordingly, the thickness of the blade 22 is substantially the same as the distance between the internal face 48a and the dividing member 80 when the barrel segment is fully assembled (see, for example FIG. 1c). In this manner, the saw blade 22 is fully secured as against unintended movement during use of the knife 30 within the respective chamber in which it is mounted.

Additionally, and as best seen in FIG. 2b, the shank portion 47b of the saw blade 22 may contain an indexing hole 29 operable to receive therethrough securing means 28 for securing blade 22 to dividing member 80. It is to be appreciated that the securing means 28 may encompass conventional securing means as by way of non limiting example screws, rivets, pins, bolts, etc.

Additional features of the barrel portion 34 according to alternate embodiments of the present invention will now be discussed with reference to FIGS. 7a to 18. It is to be understood that the same reference numerals described in the preceding paragraphs with respect to the embodiment illustrated in FIGS. 1 to 6 are analogous in structure and function to the same parts bearing the same reference numerals shown in the embodiment shown in FIGS. 7a to 18 and will not, for this reason, be again described in the following paragraphs.

In the embodiment according to the present invention shown in FIGS. 7a to 14, the barrel portion 34 is formed from a first barrel housing segment 48′ (as best seen in FIG. 7a) and a second barrel housing segment 49′ (as best seen in FIG. 7b) and a dividing member 80′ (as best seen in FIG. 7c) interposed therebetween. The two housing segments 48′, 49′ may preferably be mirror images of one another, and mate with the dividing member 80′ to form at least two internal chambers and/or longitudinal channels. Each of the longitudinal channels have different cross-sectional heights and thicknesses along the length of their longitudinal axis, with the differences therein accommodating corresponding differences in the cross-sectional height and thickness of the shank portion of an associated blade adapted to be positioned by longitudinally rearward sliding movement into a respective one of said channels. The housing segments 48′, 49′ are each pivotably mounted to the barrel portion 34 by means of a housing segment pivot 87 (as best seen in FIGS. 7a and 7b).

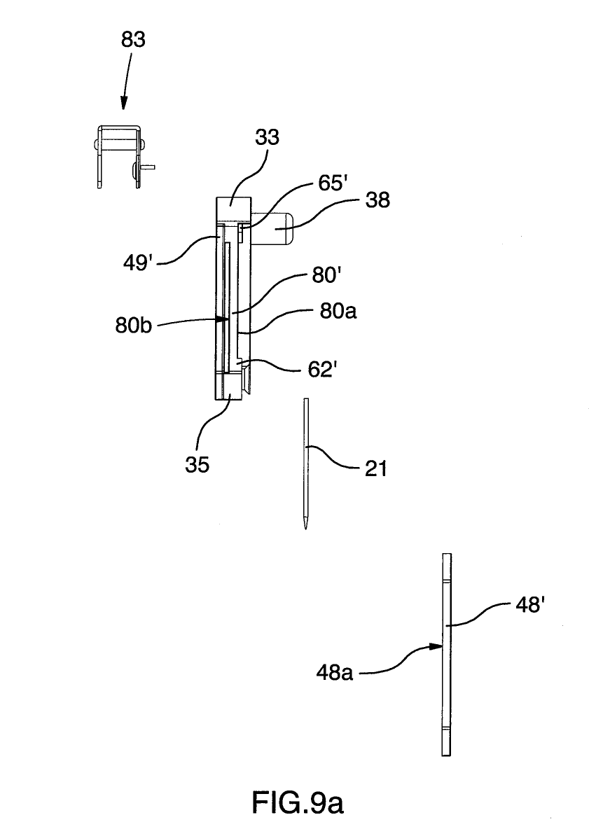

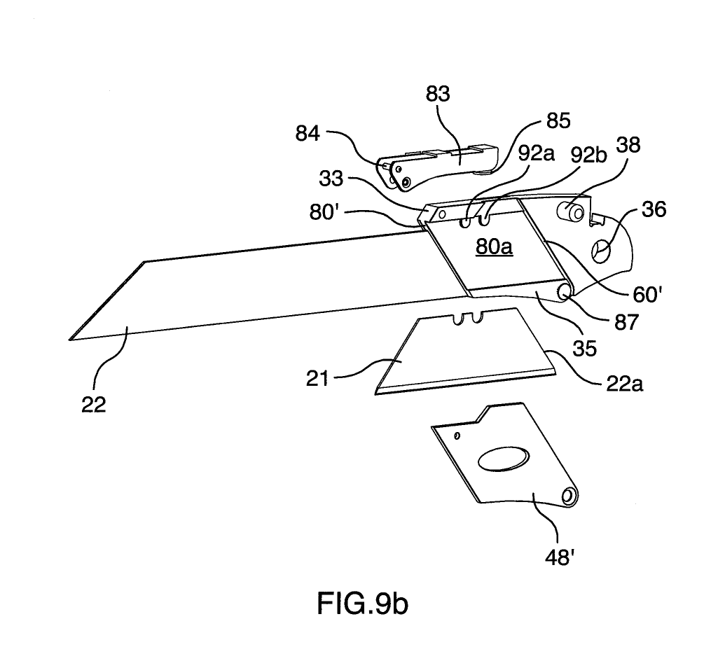

Of course it is to be appreciated that, in one embodiment (as best seen in FIGS. 7c and 9a), the dividing member 80′ may be formed with recessed receiving portions 80a, 80b being integrally molded into opposite inner surfaces of the dividing member 80′.

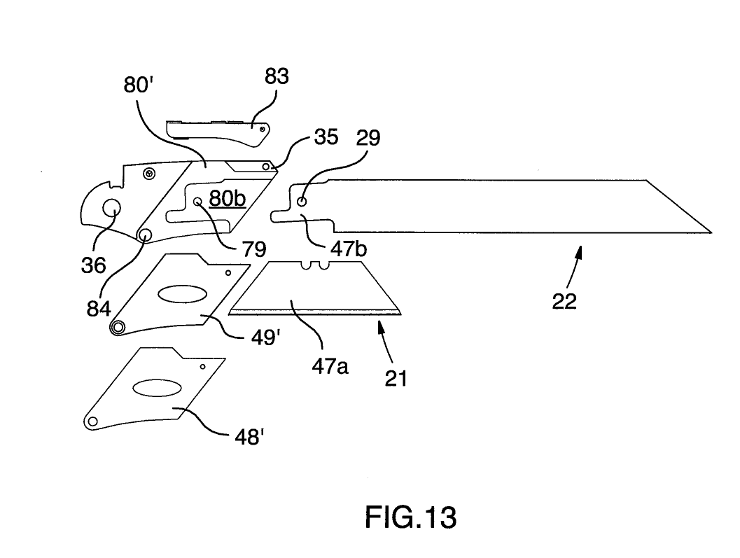

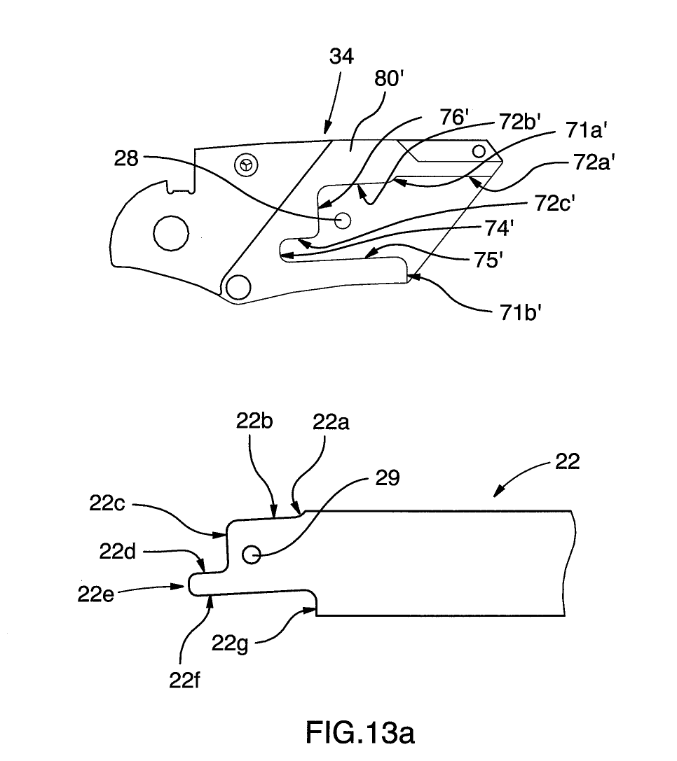

As best seen in FIGS. 9a and 9b, the recessed receiving portion 80a of the dividing member 80′ has a profile that corresponds substantially with the longitudinal profile of utility blade 21 such that a first lateral shank face of the shank portion 47a (as best seen in FIG. 13) of the utility blade 21 is received within or mates with the recessed receiving portion 80a of the dividing member 80′.

Likewise, as best seen in FIG. 13, the recessed receiving portion 80b has a profile that corresponds substantially with the longitudinal profile of wallboard blade 22 such that a first lateral shank face of the shank portion 47b of blade 22 is received within or mates with the recessed receiving portion 80b of the dividing member 80′.

To further assist in retaining the blades 21, 22 in the barrel portion 34, the hand tool 30 may be provided with blade retaining assembly operable to selectively engage a selected one of the shank portions 47a, 47b against unintentional removal of the blade 21, 22. As best seen in FIG. 9b, the blade retaining assembly comprises at least two teeth 92a, 92b, which extend downward from an upper portion 33 of the barrel portion 34, and are operable to engage with the shank portion 47a of the utility blade 21 to hold same fast with its recessed receiving portion 80a against unintentional forward sliding movement of the blade but of the barrel portion 34.

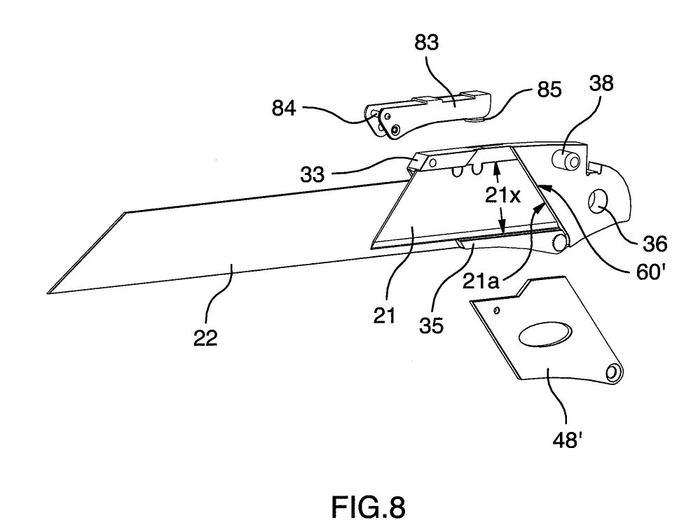

More particularly, as best seen in FIG. 8, when the conventional utility knife blade 21 is fully inserted into hand tool 30 in a rearward sliding motion into its respective chamber, each of the downwardly extending teeth 92a, 92b engages one of the respective indexing notches 25, 25. The rear edge 21a of the utility blade 21 abuts against rear shoulder 60′ of the barrel portion 34 which acts as a stop means to limit rearward sliding movement of blade 21 within its respective chamber.

In this fully inserted configuration, upward movement of the utility blade 21 is limited by engagement of the upper edge of the blade 21 with upper shoulder 65 (as best seen in FIG. 9a) of the dividing member 80′. In this fully inserted configuration, downward movement of the utility blade 21 is limited by engagement of the lower sharpened edge of the blade 21 with the lower straight edge 62′ of the dividing member 80′ (as best seen in FIG. 9a). Side-to-side movement of the utility blade 21 is limited by engagement of the first lateral shank face of the blade 21 with either the dividing member 80′ (seen in FIG. 9a) and by engagement of the opposite second lateral shank face of the blade 21 with the inner surface 48a (as best seen in FIG. 9a) of the barrel housing segment 48′. In this manner, the utility blade 21 is secured as against unintended movement during use of the knife 30, within the respective chamber in which it is mounted.

Similarly, although not shown in the appended drawings, the wall board saw blade 22 may also be provided with a plurality of indexing notches 25, 25. In this embodiment, when the wallboard saw blade 22 is fully inserted in a rearward sliding motion into its respective internal chamber, at least one of the downwardly extending teeth 92a, 92b, engages one of the respective indexing notches (not shown) to securely hold the blade 22 in its respective chamber against forward sliding movement of the blade 22.

In the embodiment shown in FIG. 13, the blade retaining assembly comprises a fastener receiving means 79 formed through dividing member 80′ and operable to receive therein a fastener to retain the wallboard saw blade 22 within its respective chamber. Additionally, the shank portion 47b of the saw blade 22 may contain an indexing hole 29 operable to receive therethrough a fastener for securing the blade 22 to the dividing member 80′.

Additionally, as best seen in FIG. 13a, the medial 22d and rear 22f trailing edges of the saw blade 22 shank portion 47b respectively engage with congruently shaped medial 76′ and rear 74′ shoulder surfaces, formed on the internal face of the recessed receiving portion 80b of the dividing member 80′ in FIG. 13a to act as stop means limiting rearward sliding movement of the blade 22 within its respective internal chamber. Similarly, an upper shoulder surface 71a′ and a lower shoulder surface 71b′ each of which are formed on the internal face of the recessed receiving portion 80b of the dividing member 80′ are each respectively engageable with the upper 22b and lower 22h trailing edges of the blade body portion (which shoulder surfaces 71a′ and 71b′ mark the transition between the blade body portion and the shank portion 47b) to limit rearward sliding movement of the blade 22 within its respective internal chamber.

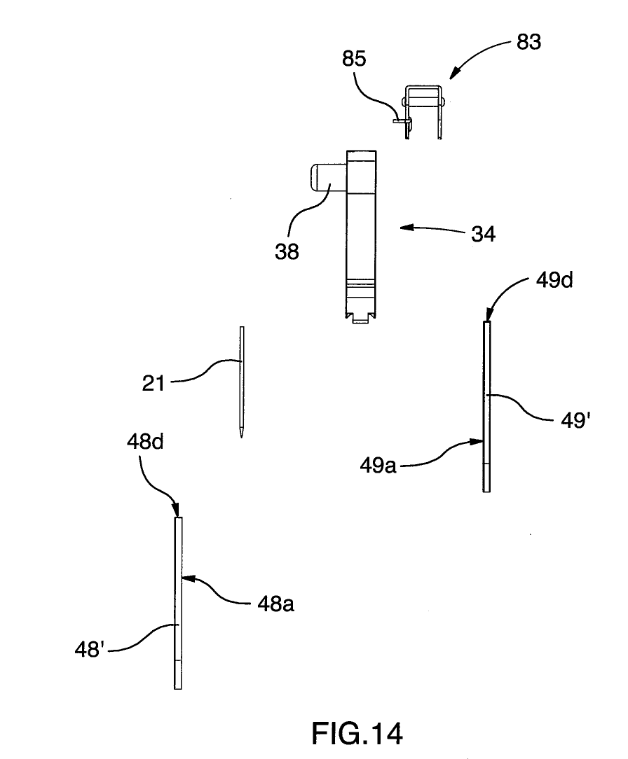

In this fully inserted configuration, upward movement of the wallboard saw blade 22 is limited by engagement of the first upper straight edge 22a, the second upper straight edge 22c and the medial straight edge 22e of the shank portion 47b of the blade 22 with upper straight shoulder surfaces 72a′, 72b′ and medial straight shoulder surface 72c′, respectively, each of which are formed on either the internal face of the recessed receiving portion 80b of the dividing member 80′ in FIG. 13a. Downward movement of the saw blade 22 is limited by engagement of the lower straight edge 22g of the shank portion 47b of the blade 22 with lower straight shoulder surface 75′ each of which are formed on either the internal face of the recessed receiving portion 80b of the dividing member 80′ in FIG. 13a. Side-to-side movement of the wallboard saw blade 22 is limited by engagement of one side face of the blade 22 with the internal face 49a of the second barrel segment 49′, and by engagement of the opposite other side face of the blade 22 with dividing member 80′. Accordingly, the thickness of the blade 22 is substantially the same as the distance between the internal face 49a (as best seen in FIG. 14) and the dividing member 80′ when the barrel segment is fully assembled. In this manner, the saw blade 22 is fully secured for use as against unintended movement during use of the knife 30 within the respective chamber in which it is mounted.

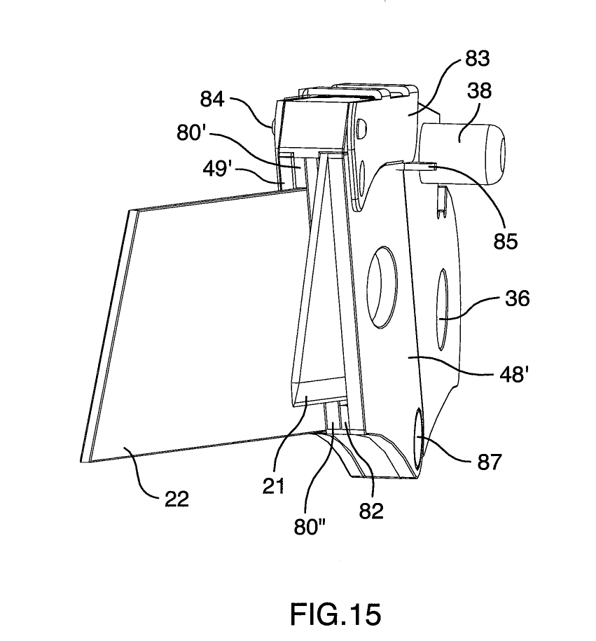

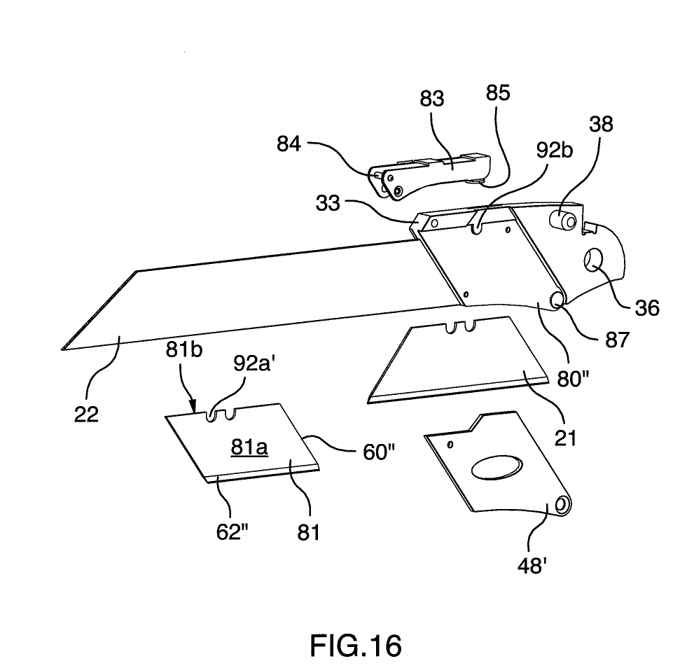

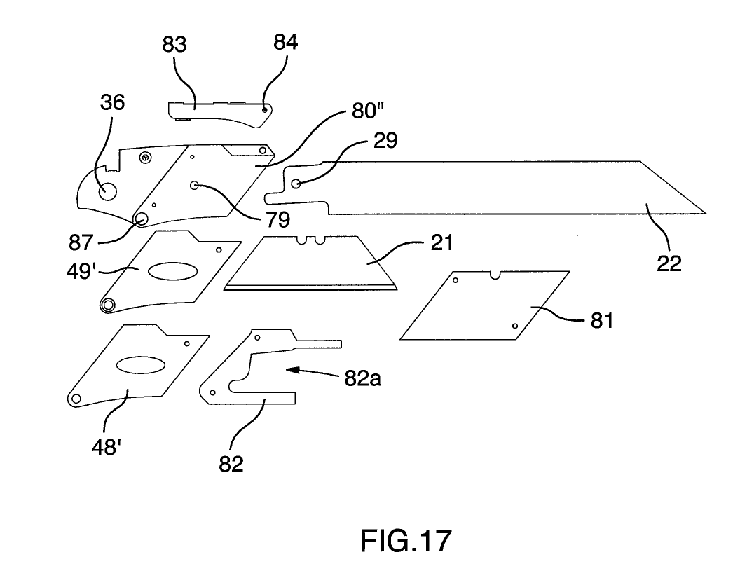

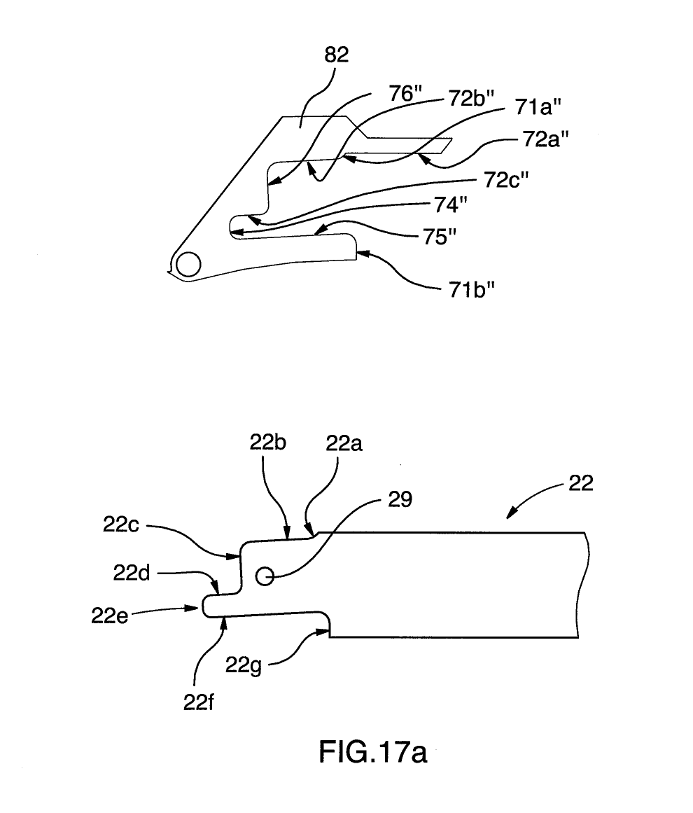

In another embodiment of the invention, as shown in FIGS. 15 to 18, the barrel portion 34, may comprise a dividing member 80″ and two recessed receiving members 81 and 82 in contacting relation with opposite sides of the dividing member 80″ along its opposed inner surfaces (as best seen in FIG. 15). The recessed receiving members 81 and 82 may be formed with recessed receiving portions 81a (as best seen in FIG. 16) and 82a (as best seen in FIG. 17) respectively. The recessed receiving members 81 and 82 are operable to receive therein a selected one of utility blade 21 or wallboard blade 22.

As best seen in FIG. 16, the recessed receiving member 81 contains a profile that corresponds substantially with the longitudinal profile of utility blade 21, such that a first lateral shank face of the shank portion 47a of the utility blade 21 is received within or mates with the recessed receiving portion 81a. Likewise, and as shown in FIG. 17, recessed receiving member 82 contains a profile that corresponds substantially with the longitudinal profile of wallboard blade 22, such that a first lateral shank face of the shank portion 47b of the wallboard blade 22 is received within or mates with the recessed receiving portion 82a.

It is to be appreciated that the recessed receiving members 81, 82 may be fastened to the dividing member 80″ by conventional fasteners (e.g. screws, rivets, etc.), not shown.

The barrel housing segments 48′ and 49′ overlay and are in contacting relation with a second lateral shank face of a selected one of utility blade 21 or wallboard blade 22. The barrel housing segments 48′ and 49′ may provide further assistance in retaining the second lateral shank faces of each of blade 21 and blade 22, respectively in mated held fast relation within the respective recessed receiving portions 81a, 82b.

To further assist in retaining the blades 21, 22 in the barrel portion 34, the hand tool 30 may be provided with blade retaining assembly operable to selectively engage a selected one of the shank portions 47a, 47b against unintentional removal of the blade 21, 22. In the embodiment shown in FIG. 16, the blade retaining assembly comprises at least one tooth 92a′ formed on an upper edge 81b of the first recessed receiving member 81 extending downward therefrom operable to engage with the shank portion 47a of the utility blade 21 to hold same fast with its recessed receiving portion 81. Another tooth 92b may be formed on the upper portion on 33 of the barrel portion 34 extending downward therefrom, and in combination with 92a on the first recessed receiving member 81 hold utility blade 20 against unintentional sliding movement out of the barrel portion 34.

More particularly, as best seen in FIG. 16, when the conventional utility knife blade 21 is fully inserted into hand tool 30 in a rearward sliding motion into its respective chamber, each of the downwardly extending teeth 92a, 92b engages one of the respective indexing notches 25, 25. The rear edge 21a of the utility blade 21 abuts against rear shoulder 60″ of the barrel portion 34 which acts as a stop means to limit rearward sliding movement of blade 21 within its respective chamber.

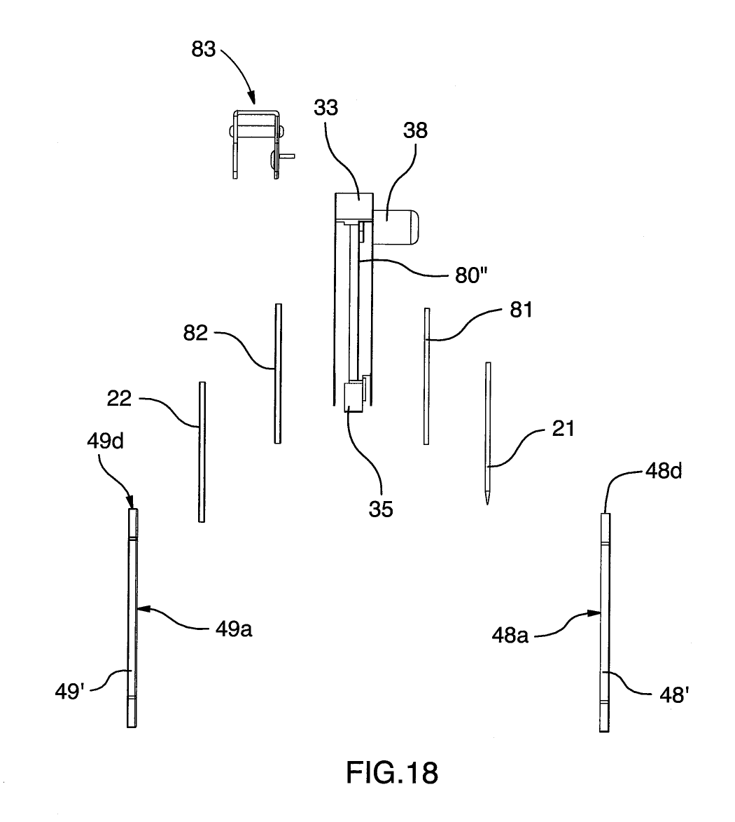

In this fully inserted configuration, upward movement of the utility blade 21 is limited by engagement of the upper edge of the blade 21 with a bottom surface of upper portion on 33 of the barrel portion 34 (as best seen in FIG. 16). In this fully inserted configuration, downward movement of the utility blade 21 is limited by engagement of the lower sharpened edge of the blade 21 with the lower straight edge 62″ (as best seen in FIG. 16) formed on the first recessed receiving member 81. Side-to-side movement of the utility blade 21 is limited by engagement of the first lateral shank face of the blade 21 with the recessed receiving member 81 (seen in FIG. 16) and by engagement of the opposite second lateral shank face of the blade 21 with the inner surface 48a (as best seen in FIG. 18) of the barrel housing segment 48. In this manner, the utility blade 21 is secured as against unintended movement during use of the knife 30, within the respective chamber in which it is mounted.

Similarly, although not shown in the appended drawings, the wall board saw blade 22 may also be provided with a plurality of indexing notches 25, 25. In this particular embodiment, when the wallboard saw blade 22 is fully inserted in a rearward sliding motion into its respective internal chamber, at least one of the downwardly extending teeth 92a, 92b, engages one of the respective indexing notches (not shown) to securely hold the blade 22 in its respective chamber against forward sliding movement of the blade 22.

In the embodiment shown in FIG. 17, the blade retaining assembly comprises a fastener receiving means 79 formed through dividing member 80″ and operable to receive therein a fastener to retain the wallboard saw blade 22 within its respective chamber. Additionally, the shank portion 47b of the saw blade 22 may contain an indexing hole 29 operable to receive therethrough a fastener for securing the blade 22 to the dividing member 80″.

Additionally, as best seen in FIG. 17a, the medial 22d and rear 22f trailing edges of the saw blade 22 shank portion 47b respectively engage with congruently shaped medial 76″ and rear 74″ shoulder surfaces, formed on the internal face of recessed receiving portion 82a of the recessed receiving member 82 in FIG. 17a, to act as stop means limiting rearward sliding movement of the blade 22 within its respective internal chamber. Similarly, an upper shoulder surface 71a″ and a lower shoulder surface 71b″ each of which are formed on the internal face of recessed receiving portion 82a of the recessed receiving member 82 in FIG. 17a, and are each respectively engageable with the upper 22b and lower 22h trailing edges of the blade body portion (which shoulder surfaces 71a″ and 71b″ mark the transition between the blade body portion and the shank portion 47b) to limit rearward sliding movement of the blade 22 within its respective internal chamber.

In this fully inserted configuration, upward movement of the wallboard saw blade 22 is limited by engagement of the first upper straight edge 22a, the second upper straight edge 22c and the medial straight edge 22e of the shank portion 47b of the blade 22 with upper straight shoulder surfaces 72a″, 72b″ and medial straight shoulder surface 72c″, respectively, each of which are formed on the internal face of recessed receiving portion 82a of the recessed receiving member 82 in FIG. 17a. Downward movement of the saw blade 22 is limited by engagement of the lower straight edge 22g of the shank portion 47b of the blade 22 with lower straight shoulder surface 75″ each of which are formed on the internal face of recessed receiving portion 82a of the recessed receiving member 82 in FIG. 17a. Side-to-side movement of the wallboard saw blade 22 is limited by engagement of one side face of the blade 22 with the internal face 49a of the second barrel segment 49′, and by engagement of the opposite other side face of the blade 22 with dividing member 80″. Accordingly, the thickness of the blade 22 is substantially the same as the distance between the internal face 49a (as best seen in FIG. 18) and the dividing member 80″ when the barrel segment is fully assembled. In this manner, the saw blade 22 is fully secured for use as against unintended movement during use of the knife 30 within the respective chamber in which it is mounted.

The barrel portion 34 further comprises a locking member 83 (as best seen in FIGS. 7c and 15). Locking member 83 has a thumb-engagement portion 85 positioned on its side surface and a mounting bearing 84. The locking member 83 is mounted for rotation about its mounting bearing 84 between a raised unlocked configuration (not shown) and a lowered, locked configuration (which configuration is illustrated in all assembly figures), and in which locked configuration the locking member 84 overlies an upper portion 33 of the barrel portion 34 and upper edges 48d, 49d (as best seen in FIGS. 14 and 18) of the housing segments 48′ and 49′, respectively to hold the housing segments 48′ and 49′ in their closed configurations as best seen in FIGS. 7c and 15. Locking member 83 is pivoted upward to the open position by a user engaging thumb engagement member 83 and rotating same upward.

A thumb rest 38 is optionally mounted in fixed relation atop the barrel portion 34 to assist the user in manipulating the knife during use.

The foregoing description has been presented for the purpose of illustration and is not intended to be exhaustive or to limit the invention to the precise form disclosed. Many modifications and variations are possible in light of the above teaching and will be apparent to those skilled in the art. For example, while knife blades of two different forms and shank profiles are shown in the drawings and described in detail above, it will be appreciated that various other tool elements may be substituted therefore, including, without limitation, those tool elements known to have been previously used as a component of the well-known Swiss Army Knife™. Appropriate modification of the shank portion of such tool elements for operative fitment within a respective recess formed within the barrel portion 34 is well within routine skill of an average person skilled in the relevant tool making art, once they have fully read, digested and understood the implications of the present disclosure. Also, while only two internal chambers each having respectively different cross-sectional heights and thickness along the length of their longitudinal axis, are formed within the barrel portion 34 described above to accommodate two different tool elements having respectively different cross-sectional shank profiles, one skilled in the art will readily appreciate that the number of such internal chambers can be increased to three, four or even more, so as to accommodate an equal plurality of corresponding tool element shank profiles. Also, while the barrel portion 34 is described above as comprising two opposed housing segments 48, 49 that mate with dividing member 80 to form two separate internal chambers, one skilled in the art will readily appreciate that the housing segments 48, 49 may mate with each other along a medial plane of the barrel portion 34, to form at least two chambers of overlapping volume that are not separated from each other by dividing member 80.

I claim:

1. A hand held cutting tool for use with at plurality of different tool elements each having a two-sided shank portion of distinct longitudinal profile, said cutting tool comprising:
(a) a barrel portion defining an equal plurality of longitudinally extending channels therewithin, with each said channel having a complimentary outline shape and otherwise dimensioned to receive one of said shank portions therewithin in close fitting relation, with a first side of said shank portion positioned adjacent the base of said channel;
(b) one or more housing means mounted on the barrel portion for selectively contacting said shank portion remote from said first side to retain the respective tool element in mated held-fast relation within each said channel; and,
(c) a handle portion attached to said barrel portion.

2. A cutting tool according to claim 1, wherein the barrel portion further comprises an inner barrel dividing member operable to divide the barrel portion into said longitudinally extending channels.

3. A cutting tool according to claim 2, wherein the dividing member is formed with at least two recessed receiving portions on opposed internally facing sides thereof, said recessed receiving portions correspond substantially with the longitudinal profile of a selected one of said tool elements and wherein a first lateral shank face of a first one of said tool elements is operable to mate with a first recessed receiving portion of said dividing member and a second lateral shank face of a second one of said tool elements is operable to mate with a second recessed receiving portion of said dividing member.

4. A cutting tool according to claim 2, wherein the barrel portion further comprises at least two recessed receiving members in contacting relation with opposite inner surfaces of the dividing member, said recessed receiving members each having a recessed receiving portion formed therein that corresponds substantially with the longitudinal profile of a selected one of said tool elements, and, wherein a first lateral shank face of a first one of said tool elements is operable to mate with a first recessed receiving portion of a first recessed receiving member and a second lateral shank face of a second one of said tool elements is operable to mate with a second recessed receiving portion of a second recessed receiving member.

5. A cutting tool according to claim 2, wherein said one or more housing means is movably mounted on the barrel portion for movement from an open position removed from overlying said dividing member and a closed position overlying said dividing member.

6. A cutting tool according to claim 5, wherein said one or more housing means is mounted on the barrel portion for selectively contacting the opposite other side of said shank portion of each said tool elements to retain the respective tool element in mated held-fast relation within each said channel.

7. A cutting tool according to claim 5, wherein said one or more housing means comprises securing plates on opposite sides of said barrel portion, with each of said securing plates being in contacting relation with a selected one of said tool elements on a second side of said shank portion adjacent to said first side when said securing plate is in the closed position.

8. A cutting tool according to claim 1, further comprising a locking member pivotally mounted on said barrel portion for movement from an open unlocked position having its longitudinal axis at least partially transverse to the barrel portion to a closed locked position having its longitudinal axis substantially parallel to said barrel portion, wherein, in said closed locked position, said locking member overlies an upper edge of said barrel portion and an upper edge of said one or more means when said one or more means is in contact with said shank portion of at least one of said tool elements.

9. A cutting tool according to claim 8, wherein said locking member is pivotally mounted on a front end of said barrel portion adjacent to said upper edge of said barrel portion.

10. A cutting tool according to claim 1, wherein the handle portion and the barrel portion are pivotally attached to each other by means of a first pivot and are selectively pivotal thereabout from an unfolded position, wherein the barrel portion and the handle portion are adjacent to each other to a folded position wherein the barrel portion is substantially received within the handle portion.

11. A cutting tool according to claim 1, wherein the handle portion further comprises a tool element storage compartment that is operable to retain therein spare tool elements.
